(19) United States
(12) Patent Application Publication
(10) Pub. No.: US 2026/0075320 A1
(43) Pub. Date: Mar. 12, 2026

(54) CAMERA ALIGNMENT USING SEMI-TRANSPARENT REFERENCE IMAGE FOR ASSET INSPECTION SYSTEMS AND METHODS

(71) Applicant: FLIR Systems AB, Täby (SE)

(72) Inventor: Regimantas Vegele, Spånga (SE)

(21) Appl. No.: 19/396,197

(22) Filed: Nov. 20, 2025

Related U.S. Application Data
(63) Continuation of application No. PCT/US2024/030439, filed on May 21, 2024.
(60) Provisional application No. 63/504,037, filed on May 24, 2023.

(51) Int. Cl. H04N 23/695; H04N 23/23; H04N 23/63; H04N 23/69

(52) U.S. Cl. CPC H04N 23/695; H04N 23/23; H04N 23/632; H04N 23/69

(57) ABSTRACT

Systems and methods directed to asset inspection are provided. In one example, a method includes capturing, by a camera, a live image of an asset under inspection. The method further includes preparing a blended image using the live image and a semi-transparent reference image of the asset, wherein the blended image comprises a first representation of the asset from the live image and a second representation of the asset from the semi-transparent reference image. The method further includes receiving, at the camera, a manipulation to align the camera relative to the asset in response to a review of an alignment of the first and second representations of the asset relative to each other in the blended image. Additional methods and systems are also provided.

### CROSS REFERENCE TO RELATED APPLICATIONS

This application is a continuation of International Patent Application No. PCT/US2024/030439 filed May 21, 2024 and entitled “CAMERA ALIGNMENT USING SEMI-TRANSPARENT REFERENCE IMAGE FOR ASSET INSPECTION SYSTEMS AND METHODS,” which claims priority to and the benefit of U.S. Provisional Patent Application No. 63/504,037 filed May 24, 2023 and entitled “CAMERA ALIGNMENT USING SEMI-TRANSPARENT REFERENCE IMAGE FOR ASSET INSPECTION SYSTEMS AND METHODS,” all of which are incorporated herein by reference in their entirety.

### TECHNICAL FIELD

The present invention relates generally to asset inspection and, more particularly, to image-based inspection of assets using reference images.

### BACKGROUND

In industrial environments such as manufacturing facilities or other locations, there is often a need to inspect various assets such as machines, electronics, or other devices. In many cases, the assets may be temperature-sensitive and therefore required to operate at temperatures within expected tolerances to facilitate ongoing reliable functionality. For example, if an asset exhibits a temperature that is too high or too low, this may indicate a fault in need of repair.

Various conventional techniques exist for monitoring assets. In some cases, large numbers of sensors or fixed camera systems may be installed throughout a facility. However, such implementations can require significant investments in infrastructure and may be cost prohibitive. Moreover, the fixed nature of such implementations can limit their ability to monitor all relevant assets in a given environment. In other cases, a user may be required to manually inspect the assets. However, this approach can be subject to human error as it puts the responsibility on the user to properly monitor the condition of the asset repeatedly. Accordingly, there is a need for an improved approach to asset monitoring.

### SUMMARY

According to various embodiments of the present disclosure, a method includes capturing, by a camera, a live image of an asset under inspection. The method further includes receiving, at the camera, a manipulation to align the camera relative to the asset based on a comparison between the live image and a reference image of the asset. The method further includes capturing, by the camera, an adjusted live image of the asset aligned with the reference image.

According to various embodiments of the present disclosure, a system includes a camera. The camera is configured to capture a live image of an asset under inspection. The camera is configured to receive a manipulation to align the camera relative to the asset based on a comparison between the live image a reference image of the asset. The camera is configured to capture an adjusted live image of the asset under inspection aligned with the reference image.

According to various embodiments of the present disclosure, a method includes capturing, by a camera, a live image of an asset under inspection. The method further includes preparing a blended image using the live image and a semi-transparent reference image of the asset, wherein the blended image comprises a first representation of the asset from the live image and a second representation of the asset from the semi-transparent reference image. The method further includes receiving, at the camera, a manipulation to align the camera relative to the asset in response to a review of an alignment of the first and second representations of the asset relative to each other in the blended image.

According to various embodiments of the present disclosure, a system includes a camera. The camera is configured to capture a live image of an asset under inspection. The camera is configured to prepare a blended image using the live image and a semi-transparent reference image of the asset, wherein the blended image comprises a first representation of the asset from the live image and a second representation of the asset from the semi-transparent reference image. The camera is configured to receive a manipulation to align the camera relative to the asset in response to a review of an alignment of the first and second representations of the asset relative to each other in the blended image.

The scope of the invention is defined by the claims, which are incorporated into this section by reference. A more complete understanding of embodiments of the present invention will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

FIG. 1 illustrates a block diagram of an inspection system and a remote system, in accordance with an embodiment of the disclosure.

FIG. 2 illustrates an imaging system configured to capture an image of an asset under inspection for comparison against a reference image, in accordance with an embodiment of the disclosure.

FIG. 3 illustrates a diagram of an example comparison between a live image of an asset under inspection and a reference image, in accordance with an embodiment of the disclosure.

FIG. 4 illustrates a diagram of another example comparison between a live image of an asset under inspection and a reference image, in accordance with an embodiment of the disclosure.

FIG. 5 illustrates a diagram of another example comparison between a live image of an asset under inspection and a reference image, in accordance with an embodiment of the disclosure.

FIG. 6 illustrates a diagram of an identifying of a detected anomaly of an asset under inspection, in accordance with an embodiment of the disclosure.

FIG. 7 illustrates a flow diagram of a process of comparing a live image of an asset under inspection against a reference image, in accordance with an embodiment of the disclosure.

FIG. 8 illustrates a live image of an asset under inspection, in accordance with an embodiment of the disclosure.

FIG. 9 illustrates a semi-transparent reference image, in accordance with an embodiment of the disclosure.

FIG. 10 illustrates a live image of an asset under inspection in relation to a semi-transparent reference image, in accordance with an embodiment of the disclosure.

FIG. 11 illustrates a blended image prepared using a live image of an asset under inspection and a semi-transparent reference image having a transparency of 50 percent, in accordance with an embodiment of the disclosure.

FIG. 12 illustrates a blended image prepared using a live image of an asset under inspection and a semi-transparent reference image having a transparency of 25 percent, in accordance with an embodiment of the disclosure.

FIG. 13 illustrates a blended image prepared using a live image of an asset under inspection and a semi-transparent reference image having a transparency of 75 percent, in accordance with an embodiment of the disclosure.

FIG. 14 illustrates a flow diagram of a process of providing a blended image prepared using a live image of an asset under inspection and a semi-transparent reference image, in accordance with an embodiment of the disclosure.

Embodiments of the present invention and their advantages are best understood by referring to the detailed description that follows. It should be appreciated that like reference numerals are used to identify like elements illustrated in one or more of the figures.

### DETAILED DESCRIPTION

Embodiments of the present disclosure provide systems and methods for asset inspection. A reference image of an asset may be used to capture a similar image of the asset repeatedly, speed up inspection, and draw correct conclusions regarding the status or health of the asset. The reference image may be a thermal and/or visible light image of the asset, such as under normal state or conditions.

During inspection of the asset, the reference image may be presented to the user, such as while the user is in front of the asset. For example, the reference image may be presented together with a live image of the asset, such as to compare the live image to the reference image (e.g., for feedback to align the images together and/or to assess a status of the asset). For instance, a manipulation may be provided to the camera to align the camera relative to the asset based on a comparison between the live image and the reference image. Presenting the reference image together with the live image may support the taking of similar images of the asset every time, which enables trending. For example, such configurations may ensure that the camera is roughly the same distance and angle towards the asset, otherwise the two images would be dissimilar.

To speed up inspection and provide decision support (e.g., to assist the user in making the correct conclusions in the field), the live image can inherit properties from the reference image, or vice versa. For example, the reference image can be prepared before being transferred to the camera. For instance, measuring tools, such as measuring spots or boxes, can be placed on areas of interest, and/or color palette, level and span, among other image properties, can be adjusted to make the areas of interest clearly visible in the image, among other properties or characteristics. In short, any kind of preparation can be applied to the reference image before transferring to the camera. The selection and preparation of the reference image can be done by the same user doing the inspection, or it can be done as guidance by a more experienced user. In embodiments, the reference image may inherit a characteristic of the live image, such as when the user changes any setting of live image. In such embodiments, the reference image may be changed correspondingly.

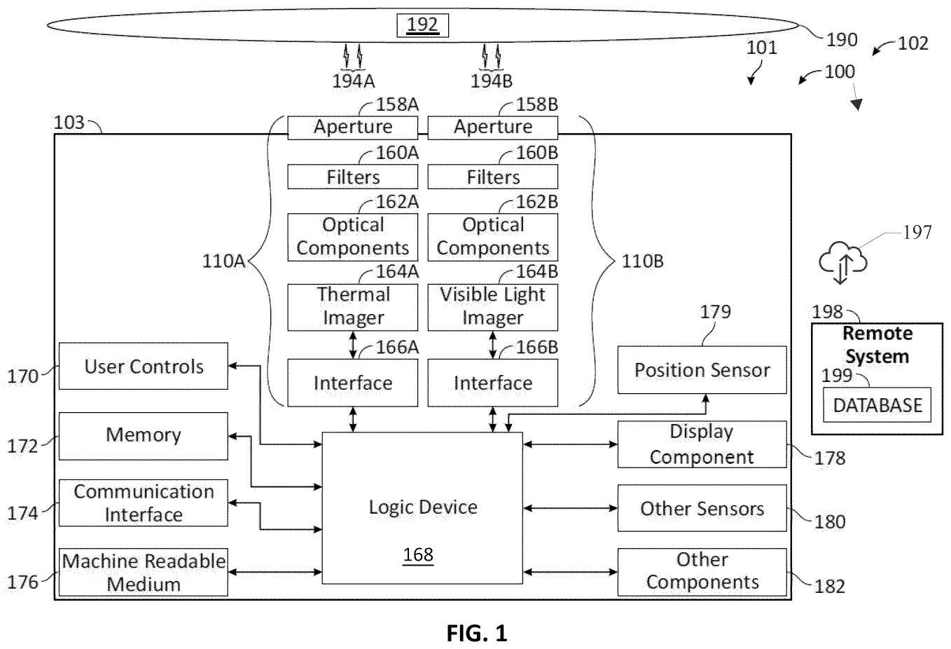

FIG. 1 illustrates a block diagram of an inspection system 100 comprising a portable device 101 and a remote system 198 in accordance with an embodiment of the disclosure. In some embodiments, portable device 101, which may be referred to as an imaging system or simply a camera, may be implemented, for example, as a handheld camera system, a small form factor camera system provided as part of part of and/or an attachment to a personal electronic device such as a smartphone, or as another device.

Portable device 101 may be positioned to receive infrared radiation 194A and/or visible light radiation 194B from a scene 190 (e.g., corresponding to a field of view of portable device 101) in an environment 102 (e.g., a workplace, warehouse, industrial site, manufacturing facility, or other environment). In various embodiments, scene 190 may include one or more physical assets 192 (e.g., temperature-sensitive machines, equipment, electronics, or other devices) of interest which may be captured in thermal images and/or visible light images by portable device 101. Although a single example asset 192 is illustrated in FIG. 1, any desired number of assets may be inspected in accordance with the techniques of the present disclosure.

As shown, portable device 101 includes a housing 103 (e.g., a camera body graspable by a user), a thermal imaging subsystem 110A, a visible light imaging subsystem 110B, a logic device 168, user controls 170, a memory 172, a communication interface 174, a machine readable medium 176, a display component 178, a position sensor 179, other sensors 180, and other components 182, or any combination thereof. Such embodiments are illustrative only, and portable device 101 may include other components facilitating the operations described herein.

Thermal imaging subsystem 110A and visible light imaging subsystem 110B may be used to capture thermal images and visible light images in response to infrared radiation 194A and visible light radiation 194B, respectively, received from scene 190.

Thermal imaging subsystem 110A may include an aperture 158A, filters 160A, optical components 162A, a thermal imager 164A, and a thermal imager interface 166A. In this regard, infrared radiation 194A passing through aperture 158A may be received by filters 160A that selectively pass particular thermal wavelength ranges (e.g., wavebands) of infrared radiation 194A. Optical components 162A (e.g., an optical assembly including one or more lenses, additional filters, transmissive windows, and/or other optical components) pass the filtered infrared radiation 194A for capture by thermal imager 164A.

Thermal imager 164A may capture thermal images of scene 190 in response to the filtered infrared radiation 194A. Thermal imager 164A may include an array of sensors (e.g., microbolometers) for capturing thermal images (e.g., thermal image frames) of scene 190. In some embodiments, thermal imager 164A may also include one or more analog-to-digital converters for converting analog signals captured by the sensors into digital data (e.g., pixel values) to provide the captured images. Thermal imager interface 166A provides the captured images to logic device 168 which may be used to process the images, store the original and/or processed images in memory 172, and/or retrieve stored images from memory 172.

Visible light imaging subsystem 110B may include an aperture 158B, filters 160B, optical components 162B, a visible light imager 164B, and a visible light imager interface 166B. It will be appreciated that the various components of visible light imaging subsystem 110B may operate in an analogous manner as corresponding components of thermal imaging subsystem 110A with appropriate technology for capturing visible light images.

Moreover, although particular components are illustrated for each of thermal imaging subsystem 110A and visible light imaging subsystem 110B, it will be understood that the illustrated components are provided for purposes of example. As such, greater or fewer numbers of components may be used in each subsystem as appropriate for particular implementations.

Logic device 168 may include, for example, a microprocessor, a single-core processor, a multi-core processor, a microcontroller, a programmable logic device configured to perform processing operations, a digital signal processing (DSP) device, one or more memories for storing executable instructions (e.g., software, firmware, or other instructions), and/or any other appropriate combinations of devices and/or memory to perform any of the various operations described herein. Logic device 168 is configured to interface and communicate with the various components of portable device 101 to perform various method and processing steps described herein. In various embodiments, processing instructions may be integrated in software and/or hardware as part of logic device 168, or code (e.g., software and/or configuration data) which may be stored in memory 172 and/or a machine readable medium 176. In various embodiments, the instructions stored in memory 172 and/or machine readable medium 176 permit logic device 168 to perform the various operations discussed herein and/or control various components of portable device 101 for such operations.

Memory 172 may include one or more memory devices (e.g., one or more memories) to store data and information. The one or more memory devices may include various types of memory including volatile and non-volatile memory devices, such as RAM (Random Access Memory), ROM (Read-Only Memory), EEPROM (Electrically-Erasable Read-Only Memory), flash memory, fixed memory, removable memory, and/or other types of memory.

Machine readable medium 176 (e.g., a memory, a hard drive, a compact disk, a digital video disk, or a flash memory) may be a non-transitory machine readable medium storing instructions for execution by logic device 168. In various embodiments, machine readable medium 176 may be included as part of portable device 101 and/or separate from portable device 101, with stored instructions provided to portable device 101 by coupling the machine readable medium 176 to portable device 101 and/or by portable device 101 downloading (e.g., via a wired or wireless link) the instructions from the machine readable medium (e.g., containing the non-transitory information).

Logic device 168 may be configured to process captured images and provide them to display component 178 for presentation to and viewing by the user. Display component 178 may include a display device such as a liquid crystal display (LCD), an organic light-emitting diode (OLED) display, and/or other types of displays as appropriate to display images and/or information to the user of portable device 101. Logic device 168 may be configured to display images and information on display component 178. For example, logic device 168 may be configured to retrieve images and information from memory 172 and provide images and information to display component 178 for presentation to the user of portable device 101. Display component 178 may include display electronics, which may be utilized by logic device 168 to display such images and information.

User controls 170 may include any desired type of user input and/or interface device having one or more user actuated components, such as one or more buttons, slide bars, knobs, keyboards, joysticks, and/or other types of controls that are configured to generate one or more user actuated input control signals. In some embodiments, user controls 170 may be integrated with display component 178 as a touchscreen to operate as both user controls 170 and display component 178. Logic device 168 may be configured to sense control input signals from user controls 170 and respond to sensed control input signals received therefrom. In some embodiments, portions of display component 178 and/or user controls 170 may be implemented by appropriate portions of a tablet, a laptop computer, a desktop computer, and/or other types of devices.

In various embodiments, user controls 170 may be configured to include one or more other user-activated mechanisms to provide various other control operations of portable device 101, such as auto-focus, menu enable and selection, field of view (FoV), brightness, contrast, gain, offset, spatial, temporal, and/or various other features and/or parameters.

Position sensor 179 may be implemented as any appropriate type of device used to determine a position (e.g., location) of portable device 101 in environment 102 (e.g., in an industrial facility containing assets 192 to be monitored). For example, in various embodiments, position sensor 179 may be implemented as a global positioning system (GPS) device, motion sensors (e.g., accelerometers, vibration sensors, gyroscopes, and/or others), depth sensing systems (e.g., time of flight cameras, LiDAR scanners, thermal cameras, visible light cameras, and/or others), antennas, other devices, and/or any combination thereof as desired. In some embodiments, position sensor 179 may send appropriate signals to logic device 168 for processing to determine the absolute and/or relative position of portable device 101 in environment 102.

Portable device 101 may include various types of other sensors 180 including, for example, temperature sensors and/or other sensors as appropriate.

Logic device 168 may be configured to receive and pass images from thermal and visible light imager interfaces 166A-B, additional data from position sensor 179 and sensors 180, and control signal information from user controls 170 to one or more external devices such as remote system 198 through communication interface 174 (e.g., through wired and/or wireless communications). In this regard, communication interface 174 may be implemented to provide wired communication over a cable and/or wireless communication over an antenna. For example, communication interface 174 may include one or more wired or wireless communication components, such as an Ethernet connection, a wireless local area network (WLAN) component based on the IEEE 802.11 standards, a wireless broadband component, mobile cellular component, a wireless satellite component, or various other types of wireless communication components including radio frequency (RF), microwave frequency (MWF), and/or infrared frequency (IRF) components configured for communication with a network. As such, communication interface 174 may include an antenna coupled thereto for wireless communication purposes. In other embodiments, the communication interface 174 may be configured to interface with a DSL (e.g., Digital Subscriber Line) modem, a PSTN (Public Switched Telephone Network) modem, an Ethernet device, and/or various other types of wired and/or wireless network communication devices configured for communication with a network.

In some embodiments, a network may be implemented as a single network or a combination of multiple networks. For example, in various embodiments, the network may include the Internet and/or one or more intranets, landline networks, wireless networks, and/or other appropriate types of communication networks. In another example, the network may include a wireless telecommunications network (e.g., cellular phone network) configured to communicate with other communication networks, such as the Internet. As such, in various embodiments, portable device 101 and/or its individual associated components may be associated with a particular network link such as for example a URL (Uniform Resource Locator), an IP (Internet Protocol) address, and/or a mobile phone number.

Portable device 101 may include various other components 182 such as speakers, displays, visual indicators (e.g., recording indicators), vibration actuators, a battery or other power supply (e.g., rechargeable or otherwise), and/or additional components as appropriate for particular implementations.

Although various features of portable device 101 are illustrated together in FIG. 1, any of the various illustrated components and subcomponents may be implemented in a distributed manner and used remotely from each other as appropriate. For example, remote system 198 may be implemented with any of the various components of portable device 101. Remote system 198 may communicate with portable device 101 to send and receive data therewith, perform remote processing for portable device 101, and/or other tasks (e.g., through appropriate communication interfaces 174 of portable device 101 and/or of remote system 198). For example, in some embodiments, thermal images, visible light images, position data, and/or additional information obtained by portable device 101 may be communicated to remote system 198 for further processing and/or storage. In this regard, remote system 198 may include a database 199 (e.g., maintained in an appropriate memory 172 of remote system 198) used for storage and recall of various images and/or other information to monitor historical temperatures of assets 192. In embodiments, remote system 198 and portable device may communicate over a network 197. For example, remote system 198 may be implemented as a cloud-based system, although other configurations are contemplated. In various embodiments, remote system 198 may include any of the various components of portable device 101 as appropriate.

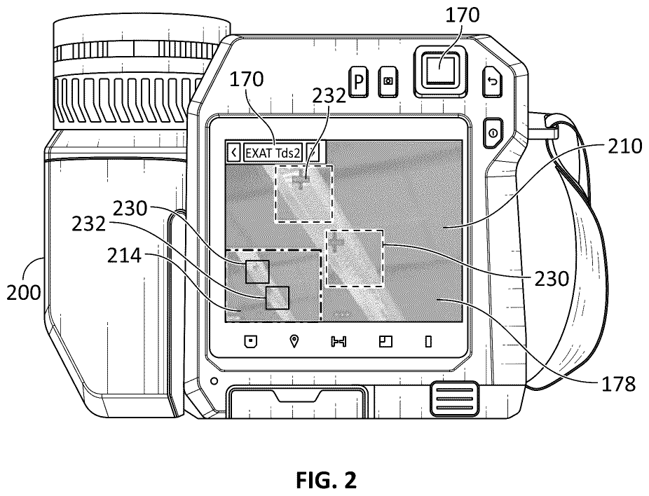

FIG. 2 illustrates an imaging system (e.g., a camera 200) configured to capture an image of an asset under inspection (e.g., asset 192) for comparison against a reference image, in accordance with an embodiment of the disclosure. Camera 200 may be similar to portable device 101 described above, such that camera 200 is a particular implementation of portable device 101. For example, camera 200 may include thermal imaging subsystem 110A and/or visible light imaging subsystem 110B, user controls 170, display component 178, and other components of portable device 101, described above. Although described as a thermal and/or visible light imaging system, camera 200 may be or include any other type of imaging system.

Referring to FIG. 2, camera 200 is configured to capture a live image 210 of an asset under inspection (e.g., asset 192). For example, during an inspection of asset 192, camera 200 may capture live image 210 for use in monitoring a condition of asset 192, such as to detect faults, failures, or undesired operating conditions of asset 192. In embodiments, live image 210 may be presented together with a reference image 214 of asset 192. For example, display component 178 may be configured to display live image 210 and reference image 214 simultaneously for viewing by a user of camera 200, although other implementations are contemplated, as described below. For instance, in some implementations, live image 210 and reference image 214 may be displayed on a remote display component, such as on a display component of remote system 198, although other configurations are contemplated.

Reference image 214 may be any image used to identify an inspection condition of asset 192 based on a comparison with live image 210. For example, reference image 214 may be an image of asset 192 itself, such as an image taken by an installer during installation of asset 192, an image taken by a manufacturer during manufacture of asset 192, or any other image of asset 192 taken at any time prior to live image 210. In some embodiments, reference image 214 may be an image of a similar asset and not of asset 192 itself. For instance, reference image 214 may be an image of another device/equipment of the same model as asset 192 (e.g., a standard image of asset model, the same asset at another location, etc.) or an image of another device/equipment having properties and/or a configuration similar to asset 192 (e.g., a prior model of asset 192, a comparable model of asset 192, etc.).

Reference image 214 may be provided in many ways. For example, reference image 214 may be provided (e.g., to camera 200) by an image database maintained by a server (e.g., by database 199 of remote system 198). In some embodiments, reference image 214 may be taken by a second camera different than camera 200. For example, as noted above, reference image 214 may be taken by the installer during installation of asset 192, by the manufacturer during manufacture of asset 192, or by another person or device.

In embodiments, reference image 214 may be selected or identified (e.g., by a user, by system 100, etc.) for use in comparing against live image 210. For example, using user controls 170, a user may select, from among multiple images, an image to use as reference image 214, such as toggling between various prior images of asset 192. In this manner, the user may toggle between a time series of images of asset 192, such as to provide additional decision support. Such embodiments may also enable a trend plot of temperature values to be presented for a measurement tool, which may provide additional decision support. In embodiments, reference image 214 may be selected automatically, or at least selected by default, based on a user setting. For instance, the user setting may include at least one of a “last asset inspection” setting, a “first image taken of the asset” setting, or a “last image associated with a similar time or environmental condition of the live image” setting, although other configurations are contemplated. The “last asset inspection” setting may select, as default, the last inspection image of asset 192 as reference image 214. The “first image taken of the asset” setting may select, as default, the earliest image taken of asset 192 as reference image 214. The “last image associated with a similar time or environmental condition of the live image” setting may select, as default, the latest image of asset 192 taken during a similar time of day and/or year (e.g., morning, afternoon, fall, October, etc.) and/or similar environmental conditions (e.g., ambient temperature, etc.) as reference image 214, such as for assets whose temperature may vary over the year. Depending on the application, the selection of reference image 214 can be done by the same user doing the inspection, or the selection can be done as guidance by a more experienced user.

As shown in FIG. 2, live image 210 is displayed adjacent (e.g., side-by-side) reference image 214 to facilitate a comparison between live image 210 and reference image 214. For example, live image 210 and reference image 214 may be presented together to allow a user (e.g., a user of camera 200, a remote user, etc.) to compare live image 210 and reference image 214 side-by-side. In embodiments, reference image 214 may be displayed picture-in-picture with live image 210, such as at a corner of live image 210, although other configurations are contemplated. In embodiments, the display characteristics of live image 210 and reference image 214 may be adjusted by user preference. For instance, a user may adjust the size and position of reference image 214 relative to live image 210, as desired, to aid in comparing live image 210 to reference image 214.

In embodiments, camera 200 and/or system 100 may apply a characteristic associated with reference image 214 or live image 210 to live image 210 or reference image 214 prior to displaying the images. The characteristic may include temperature measuring functions, properties that affect the appearance of the image, and/or properties that affect the temperature reading of asset 192. For example, reference image 214 may be prepared to include measuring tools (e.g., temperature measurement box(es) 230, temperature measurement spot(s) 232, etc.) placed on areas of interest and/or by adjusting image characteristics (e.g., color palette, temperature span settings, thermal brightness (level) settings, etc.) in a way to make areas of interest clearly visible. In embodiments, the characteristic may include other image properties/characteristics, such as various image parameters/properties and/or other data associated with the image (e.g., ambient temperature, time, user, camera type/model, location, position, etc.). Such examples are illustrative only, and any kind of preparation can be applied to reference image 214 before transferring to camera 200. Depending on the application, the preparation of reference image 214 can be done by the same user doing the inspection, or the preparation can be done as guidance by a more experienced user.

Live image 210 may inherit the characteristics of reference image 214 described above. For example, live image 210 may inherit any or all measurement functions (e.g., temperature measurement box(es) 230, temperature measurement spot(s) 232, etc.) and their placement from reference image 214, leading to an efficient inspection of asset 192 as live image 210 is automatically prepared with the correct measuring tools in place. Additionally, or alternatively, live image 210 may inherit the image characteristics and/or properties of reference image 214, such as color palette, temperature span, level, emissivity, distance to object, ambient temperature, etc. In this manner, the system may ensure that a user is looking at images with the same visual presentation to aid in inspection (e.g., to ensure an “apples-to-apples” comparison). For example, with the same properties controlling the presentation of the images, something that appears warmer in one image will be warmer. Although live image 210 is described as inheriting a characteristic of reference image 214, in embodiments, reference image 214 may inherit a characteristic of live image 210 (e.g., should the user change any setting of live image 210, reference image 214 is changed correspondingly).

Comparison between live image 210 and reference image 214 may facilitate the taking of similar images of asset 192 every time. For example, comparing live image 210 to reference image 214 may ensure that camera 200 is roughly the same distance and angle towards asset 192 during inspection; otherwise, the two images may not look similar or capture the same information. To that end, camera 200 may be configured to receive a manipulation to align camera 200 relative to asset 192 based on a comparison between live image 210 and reference image 214. The manipulation may adjust at least one of a position, an angle, or a field of view of camera 200 to align live image 210 with reference image 214. Depending on the application, the manipulation may be performed by the user of camera 200, such as in real time based on user comparison of live image 210 to reference image 214, or the manipulation may be performed by another device (e.g., a robot operated by system 100 and/or remote system 198), although other configurations are contemplated.

Once live image 210 and reference image 214 are (or appear) similar, camera 200 may capture an adjusted live image of asset 192, the adjusted live image aligned with reference image 214. The adjusted live image may then be used to determine a status, condition, or operational state of asset 192. For example, the adjusted live image may display or otherwise identify a fault, failure, or undesired operation condition of asset 192, or that asset 192 is operating satisfactorily. The adjusted live image may be stored (e.g., in camera 200, in database 199, etc.) for use in future inspections of asset 192. For example, the adjusted live image may be used as reference image 214 in future inspections of asset 192.

Depending on the application, live image 210, reference image 214, and the adjusted live image may be thermal images, such as captured by thermal imaging subsystem 110A. In embodiments, camera 200 may be configured to capture a visible light live image of asset 192 (e.g., as captured by visible light imaging subsystem 110B) and receive a visible light reference image of asset 192. In such embodiments, the manipulation of camera 200 to align live image 210 with reference image 214 may be based on a comparison between the visible light live image and the visible light reference image.

In some embodiments, camera 200 may be configured to process the thermal live image and the visible light live image to provide a combined live image. Camera 200 may also process the thermal reference image and the visible light reference image to provide a combined reference image. In such embodiments, the manipulation of camera 200 to align live image 210 with reference image 214 may be based on a comparison between the combined live image and the combined reference image. The combined live image and the combined reference image may be generated using various thermal plus visible light combining techniques as further discussed herein.

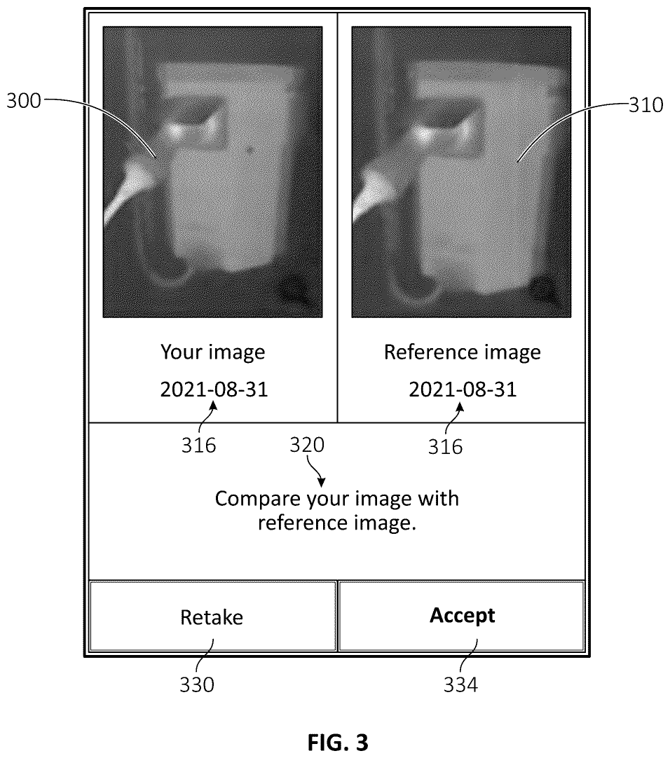

FIGS. 3-5 illustrate diagrams of various example comparisons between a live image of an asset under inspection and a reference image, in accordance with an embodiment of the disclosure. Referring to FIG. 3, a live image 300 may be displayed together with a reference image 310 on a display component (e.g., display component 178). As shown, live image 300 and reference image 310 may be presented side-by-side. Each of live image 300 and reference image 310 may include data related to when the image was captured (e.g., image capture information 316). In embodiments, the system may provide an indication 320 reminding the user to compare live image 300 with reference image 310. In embodiments, the system may include a first executable control 330 that causes the system to accept live image 300, and a second executable control 334 that causes the system to retake live image 300, although other configurations are contemplated.

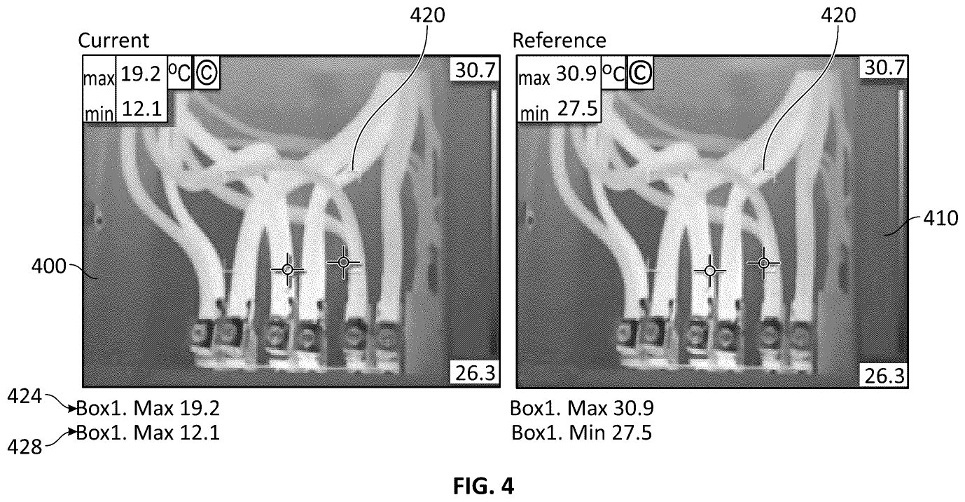

Referring to FIG. 4, a live image 400 may be displayed together (e.g., side-by-side) with a reference image 410. As shown, each of live image 400 and reference image 410 may include a temperature measurement box 420, with a maximum temperature 424 and a minimum temperature 428 in the box 420 indicated (e.g., below the images).

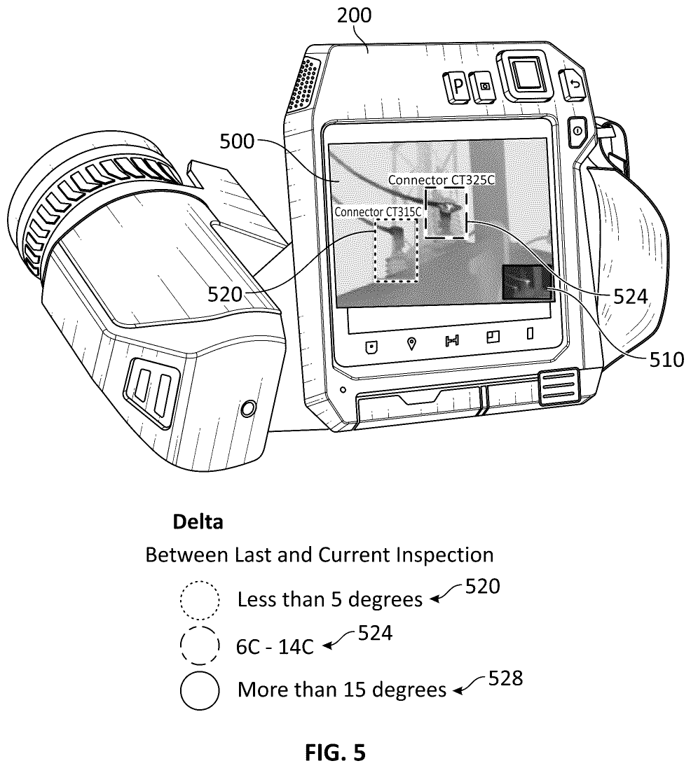

Referring to FIG. 5, a live image 500 may be displayed prominently relative to a reference image 510. For example, live image 500 may fill a substantial portion of display component 178 of camera 200, with reference image 510 taking up a smaller portion of display component 178. As shown, the system may be configured to identify, such as highlight, (e.g., on display component 178) a detected difference between live image 500 and reference image 510. For instance, the system may visually identify temperature differences of certain portions or elements in live image 500 compared to reference image 510. In embodiments, temperature differences may be highlighted differently based on the delta amount, such as with a first indication 520 (e.g., a first color) for small temperature differences (e.g., less than 5° C.), a second indication 524 (e.g., a second color) for moderate temperature differences (e.g., between 6° C. and 14° C.), and a third indication 528 (e.g., a third color) for large temperature differences (e.g., greater than 15° C.), although other configurations are contemplated. In embodiments, an alarm may be provided based on the detected difference exceeding a threshold, such as if a detected temperature difference exceeds a temperature limit, among other examples.

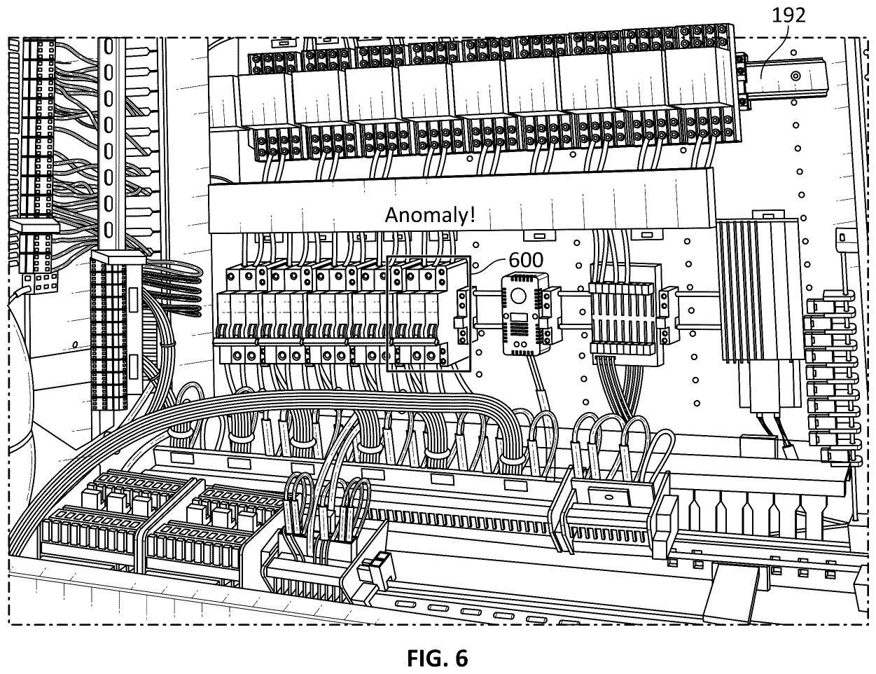

FIG. 6 illustrates a diagram of an identifying of a detected anomaly of an asset under inspection, in accordance with an embodiment of the disclosure. Referring to FIG. 6, the system may be configured to identify detected faults, failures, or other anomalies of asset 192. For example, based on data received from live and reference images of asset 192, the system may identify and flag (e.g., automatically) inspection issues, such as via a box 600 or another indication. As shown, the identification of faults or failures may be highlighted in a visible light image to facilitate user identification of faulty components or equipment, although other configurations are contemplated. For example, some types of problems can be clearly seen in a visible light image but not in a thermal image. The user may toggle between thermal and visible light images of asset 192. In such embodiments, measurement functions and their results can be inherited from a thermal reference image to the visible light live image, even if the user is using the visible/visual portion of the image. The measurement functions and their results may also be presented on the visible light image with correct location and measurement results.

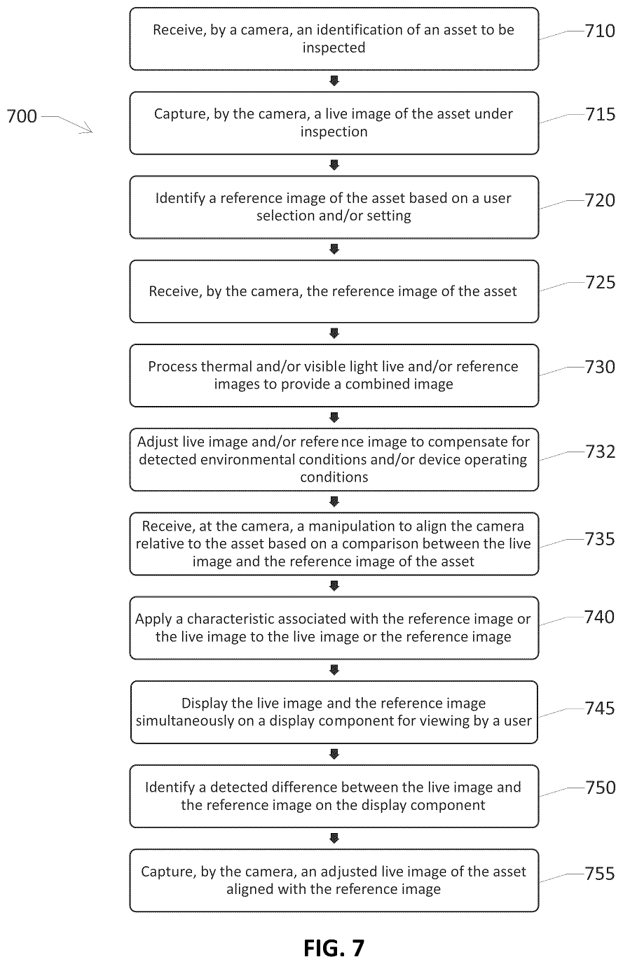

FIG. 7 illustrates a flow diagram of a process 700 of comparing a live image of an asset under inspection against a reference image, in accordance with an embodiment of the disclosure. In this regard, process 700 may operate in relation to any of the various live images, reference images, and/or combined images discussed herein and/or illustrated in the various drawings of the present disclosure. In embodiments, process 700 may be performed by logic device 168 of portable device 101 (e.g., camera 200) and/or remote system 198. In some embodiments, process 700 may be performed during runtime operation of inspection system 100 to permit real-time inspection of one or more assets (e.g., asset 192). Note that one or more operations in FIG. 7 may be combined, omitted, and/or performed in a different order as desired.

In block 710, process 700 includes receiving (e.g., by camera 200) an identification of an asset to be inspected. For example, asset 192 may be flagged as needing inspection, such as during routine inspections of one or more assets in a warehouse, on an industry floor, etc. In embodiments, the identification of asset 192 to be inspected may be based on at least one of a predetermined inspection route, a detected position of camera 200 relative to asset 192 (e.g., GPS positioning), a communication between camera 200 and asset 192 (e.g., near-field communication (NFC), wireless communication, Bluetooth communication, etc.), or user input. For example, during routine inspections, the user may provide an indication (e.g., via user controls 170, voice control, etc.) to proceed to the next asset for inspection. In embodiments, the use of an inspection route may be the same or similar to that disclosed in U.S. Provisional Patent Application No. 63/003,111, filed Mar. 31, 2020, and International Patent Application No. PCT/US2021/025011 filed Mar. 30, 2021, all of which are hereby incorporated by reference in their entirety.

In block 715, process 700 includes capturing (e.g., by camera 200) a live image (e.g. live image 210) of the asset under inspection. For instance, thermal imaging subsystem 110A and/or visible light imaging subsystem 110B may be used to capture a thermal live image and/or a visible light live image of asset 192, such as in a manner as described above.

In block 720, process 700 includes identifying a reference image of the asset based on a user selection and/or a setting. The user setting may include at least one of a “last asset inspection” setting, a “first image taken of the asset” setting, or a “last image associated with a similar time or environmental condition of the live image” setting, as described above. Such implementations are exemplary only, and other configurations are contemplated.

In block 725, process 700 includes receiving (e.g., by camera 200) the reference image of the asset. Block 725 may include receiving the reference image from an image database maintained by a server (e.g., database 199 of remote system 198). The reference image may be taken by a second camera different than camera 200. For example, the reference image may be an image taken by an installer during installation of asset 192, an image taken by a manufacturer during manufacture of asset 192, or any other image of asset 192 taken at any time prior to live image. The reference image may be an image of asset 192 itself, or an image of a different asset. The reference image may be a thermal reference image or a visible light reference image.

In some embodiments, process 700 may include optional block 730 wherein thermal and/or visible images may be combined to provide combined live images and/or combined reference images comprising thermal image content and visible light image content. For example, block 730 may include processing a thermal live image and a visible light live image to provide a combined live image, processing a thermal reference image and a visible light reference image to provide a combined reference image, and/or other processing. In some embodiments, the processing performed in block 730 may include any of the various techniques set forth in U.S. Pat. Nos. 8,520,970, 8,565,547, 8,749,635, 9,171,361, 9,635,285, and/or 10,091,439, all of which are hereby incorporated by reference in their entirety. In some embodiments, such processing may include, for example, contrast enhancement processing (e.g., also referred to as MSX processing, high contrast processing, and/or fusion processing), true color processing, triple fusion processing, alpha blending, and/or other processing as appropriate.

Such combined live images and/or combined reference images may be used as the live images and/or reference images in other blocks of process 700 described herein to facilitate convenient review of such combined images and ease of alignment by a user or by another device. For example, in some embodiments, such combined images may permit a high resolution visible light features to be discerned simultaneously with low resolution thermal features.

In some embodiments, process 700 may include optional block 732, where the live image and/or the reference image is adjusted to compensate for detected environmental conditions and/or device operating conditions. For example, one or more sensors may monitor ambient temperate, device temperature, humidity, and/or other conditions of the environment, which may affect camera operation and/or image capture/characteristics. In such embodiments, block 732 may compensate for the detected conditions, such that the live and reference images are similar for comparison purposes.

In block 735, process 700 includes receiving (e.g., at camera 200) a manipulation to align the camera relative to the asset based on a comparison between the live image and the reference image of the asset. The manipulation may adjust at least one of a position, an angle, or a field of view of the camera to align the live image with the reference image. The manipulation may be performed by the user of the camera, or by another device (e.g., a robot, a machine, etc.), as described above. The manipulation and comparison may be based on thermal imagery, visible light imagery, or combined thermal and visible light imagery, as noted above.

In block 740, process 700 includes applying a characteristic associated with the reference image or the live image to the live image or the reference image. The characteristic applied may include temperature measuring tools or functions (e.g., temperature measurement box(es) 230, temperature measurement spot(s) 232) placed on areas of interest, properties that affect the appearance of the image (e.g., color palette, span, level), and/or properties that affect the temperature reading (e.g., emissivity, distance to object, ambient temperature) of asset 192, among other characteristics.

In block 745, process 700 includes displaying the live image and the reference image simultaneously on a display component for viewing by a user. For example, the live and reference images may be displayed on display component 178 of portable device 101/camera 200 and/or a display component of a remote device (e.g., of remote system 198, a smartphone, etc.). The live and reference images may be displayed side-by-side, picture-in-picture, vertically stacked, or in other configurations. For example, the live and reference images may be displayed as shown in FIGS. 2-5, described above.

In block 750, process 700 includes identifying a detected difference between the live image and the reference image on the display component. Block 750 may include visually highlighting, flagging, or otherwise noting differences between the live image and the reference image, such as identified by the user. In embodiments, the differences between the live image and the reference image may be detected using a processor (e.g., logic device 168 of portable device 101/camera 200 and/or remote system 198), such as via a neural network running a machine learning algorithm or other artificial intelligence. Block 750 may include boxing or otherwise isolating the detected difference, such as in a manner as explained with reference to FIGS. 5-6, described above.

In block 755, process 700 includes capturing (e.g., by camera 200) an adjusted live image of the asset aligned with the reference image. For example, once the live image and the reference image are (or at least appear) similar, thermal imaging subsystem 110A and/or visible light imaging subsystem 110B may capture a thermal live image and/or a visible light live image of asset 192 aligned with the reference image, such as in a manner as described above. In embodiments, the adjusted live image may be used as a reference image in future inspections of asset 192.

In view of the present disclosure, it will be appreciated that various techniques are provided to facilitate alignment of live images with reference images to permit comparable and useful images to be repeatedly captured of an asset under inspection. Repeated capture of comparable and useful images of the asset may speed up inspection and lead to correct conclusions regarding the status or health of the asset. For example, the live image may be presented together with a reference image to facilitate quick identification of any differences in the live image from the reference image, such as a change in temperature. To aid inspection and increase efficiency, the live image can inherit properties from the reference image, or vice versa, such that the images appear similar for the comparison.

In some embodiments, block 715 (e.g., the capture of the live image) may be repeated and may continue throughout process 700 such that the live image is repeatedly updated to provide a current live image (e.g., a plurality of successive live images). Also in some embodiments, block 735 (e.g., the manipulation of camera 200) may be repeated and may continue throughout process 700. Also in some embodiments, block 745 (e.g., the display of the live image and the reference image) may be performed between blocks 732 and 735 and may be repeated and may continue throughout process 700 such that a user of camera 200 may simultaneously view the live image and the reference image while performing the manipulation of block 735. As a result, the user may repeatedly view the displayed current live image and reference image while manipulating camera 200 to further align camera 200 relative to the asset.

Additional embodiments are also contemplated. Although live images have been primarily illustrated and discussed as being positioned adjacent to (e.g., side-by-side or otherwise) reference images, other display techniques may be used. For example, reference images may be partially or fully superimposed on live images to provide a blended image that aids a user in aligning a camera relative to an asset under inspection. Such an approach can substantially assist the user in aligning a camera to achieve a desired distance, angle, and orientation relative to an asset under inspection to match reference images and therefore capture images from repeatable vantage points to provide useful images for comparison with previously captured images and future captured images.

In this regard, by superimposing a reference image over a live image, the user may manipulate the camera until the live image substantially matches the reference image (e.g., until the size, orientation, position, and/or other features of the asset in the live image substantially match the reference image) such that the blended image exhibits little to no misalignment (e.g., offset) in the live image representation of the asset and the reference image representation of the asset. Moreover, by using a superimposition-based alignment, a user may review a single blended image comprising the superimposed reference image and live image (e.g., rather than switching the user's gaze between different images that may be simultaneously but separately displayed adjacent to each other or otherwise). As a result, the user may review such a blended image and align the camera with the more rapidly and more accurately.

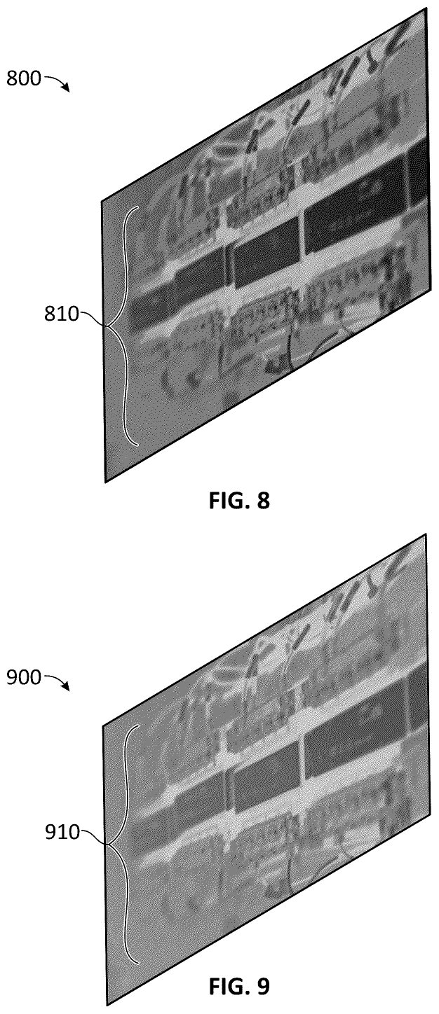

To further aid in such superimposition-based alignment, reference images may be presented in a semi-transparent manner. In some embodiments, semi-transparent reference images may be prepared by processing existing opaque reference images (e.g., by logic device 168 of portable device 101 and/or by remote system 198). In some embodiments, a user may select a transparency amount (e.g., predetermined or in realtime) to selectively adjust the amount of transparency exhibited by the semi-transparent reference images. Such an approach permits users to achieve improved alignment and ease of use as different transparency amounts may be more beneficial under various operating conditions and/or environmental conditions. Such features can be further appreciated in relation to FIGS. 8-14.

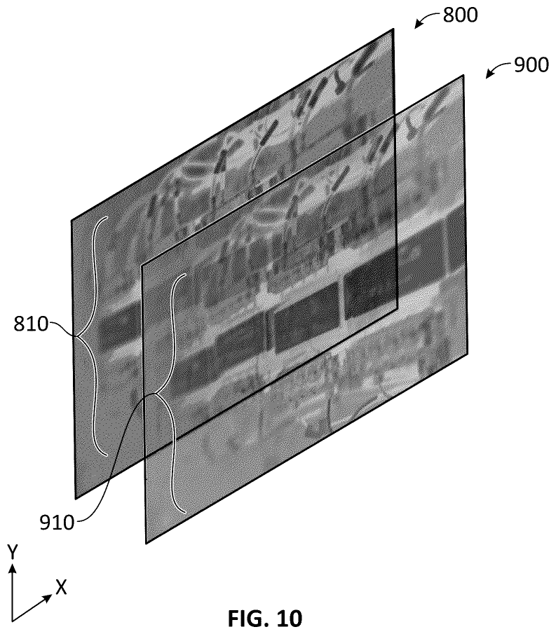

For example, FIG. 8 illustrates a live image 800 of an asset under inspection (e.g., depicted in image portion 810), FIG. 9 illustrates a semi-transparent reference image 900 of the same asset as live image 800 (e.g., depicted in image portion 910), and FIG. 10 illustrates live image 800 in relation to semi-transparent reference image 900, in accordance with embodiments of the disclosure.

As shown in FIG. 10, reference image 900 may be superimposed over live image 800 (e.g., images 800 and 900 are shown displaced in relation to each other in FIG. 10 for illustration purposes to aid the reader in discerning the relative alignment of the images in the X-Y plane). As a result, when blended together, image portions 810 and 910 depicting the asset under inspection may be easily viewed in relation to each other.

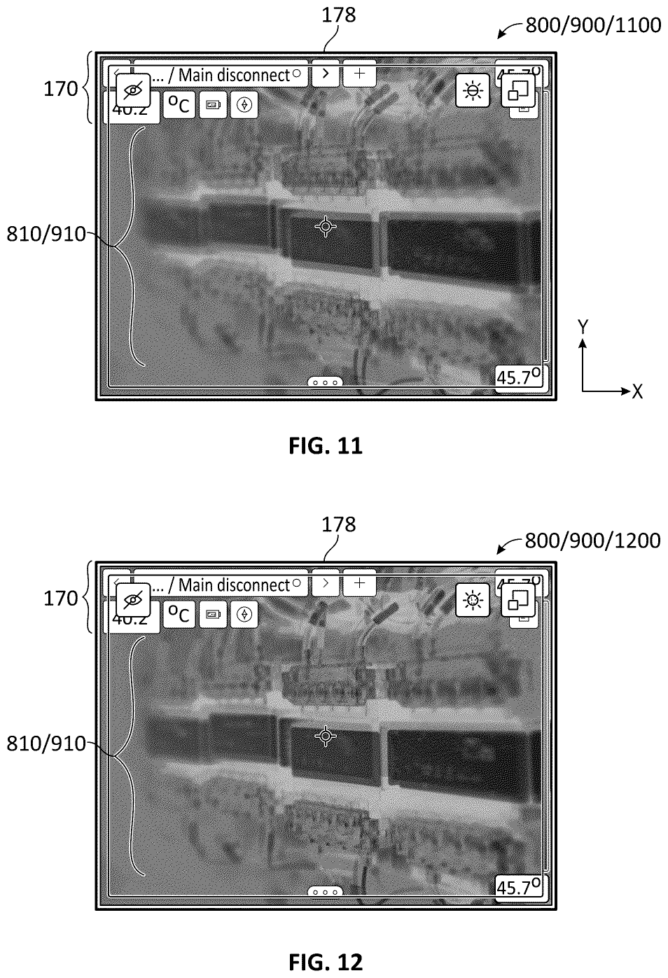

In this regard, FIG. 11 illustrates a blended image 1100 prepared using live image 800 and reference image 900, in accordance with an embodiment of the disclosure. For example, blended image 1100 may be displayed on display component 178 of camera 200 with additional user controls 170 and other information as appropriate.

As shown in FIG. 11, image portions 810 and 910 for the asset are both illustrated in blended image 1100 and are slightly offset in relation to each other for illustration purposes (e.g., image portions 810 and 910 are slightly translated in both the X axis and the Y axis relative to each other). Accordingly, while a user views blended image 1100, the user may manipulate camera 200 to further align image portions 810 and 910 if desired until they substantially overlap each other with little or no offset. When so aligned, live image 800 may be captured, stored, and/or otherwise maintained for future reference to aid in the inspection and review of the asset.

In some embodiments, camera 200 optionally receives a user selection of a transparency amount (e.g., the opacity) to be used for semi-transparent reference image 900. For example, in some embodiments, a user of camera 200 may operate user controls 170 and/or other portions of camera 200 to select the transparency amount. In some embodiments, the transparency amount may be identified by a transparency percentage (e.g., 25 percent, 50 percent, 75 percent, or others) or other appropriate metric.

In some embodiments, live image 800 may be a fully opaque image (e.g., having a transparency of 0 percent). In such embodiments, superimposing semi-transparent reference image 900 over opaque live image 800 will result in some of opaque live image 800 being visible behind (e.g., through) semi-transparent reference image 900.

For example, in blended image 1100, semi-transparent reference image 900 has a transparency amount of 50 percent and opaque live image 800 has a transparency amount of 0 percent. In this case, semi-transparent reference image 900 contributes 50 percent to blended image 1100 and opaque live image 800 contributes a remaining 50 percent to blended image 1100. As a result, live image 800 and semi-transparent reference image 900 are equally visible in blended image 1100.

As another example, FIG. 12 illustrates a blended image 1200 (e.g., as displayed by display component 178 of camera 200), in accordance with an embodiment of the disclosure. Here, semi-transparent reference image 900 has a transparency amount of 25 percent and opaque live image 800 has a transparency amount of 0 percent. In this case, semi-transparent reference image 900 contributes 75 percent to blended image 1200 and opaque live image 800 contributes a remaining 25 percent to blended image 1200. As a result, semi-transparent reference image 900 may be substantially more visible than live image 800 in blended image 1200.

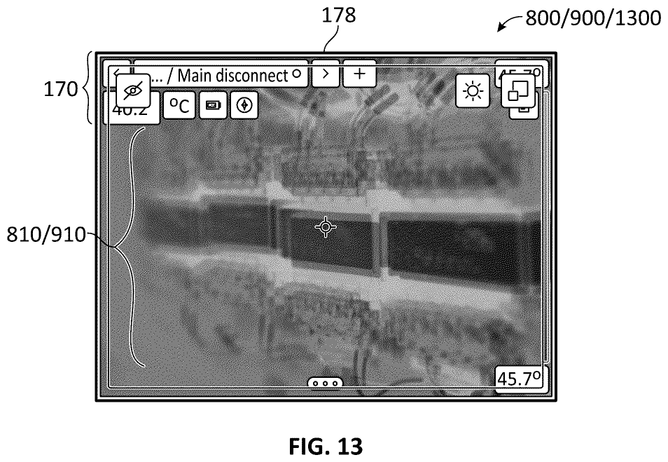

As another example, FIG. 13 illustrates a blended image 1300 (e.g., as displayed by display component 178 of camera 200), in accordance with an embodiment of the disclosure. Here, semi-transparent reference image 900 has a transparency amount of 75 percent and opaque live image 800 has a transparency amount of 0 percent. In this case, semi-transparent reference image 900 contributes 25 percent to blended image 1300 and opaque live image 800 contributes a remaining 75 percent to blended image 1200. As a result, semi-transparent reference image 900 may be substantially less visible than live image 800 in blended image 1300.

Thus, it will be appreciated that the proportions of live image 800 and semi-transparent reference image 900 exhibited by the resulting blended image may be selectively adjusted as desired by a user to achieve a preferred representation as may be appropriate for various conditions or user preferences. Various techniques may be used to provide transparency such as alpha blending, alpha channel processing, pixel-specific transparency, and/or other techniques as appropriate.

Although user-selectable transparency amounts have been discussed, other approaches are also contemplated. For example, a predetermined transparency amount (e.g. 50 percent or other amount) may be used in place of the user selection.

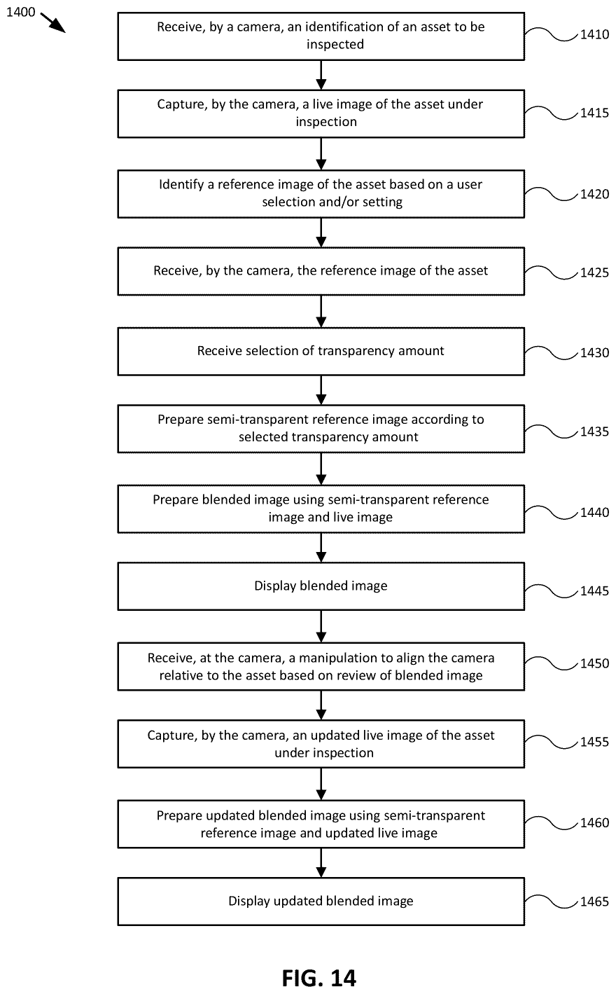

FIG. 14 illustrates a flow diagram of a process 1400 of providing a blended image prepared using live image 800 and a semi-transparent reference image 900, in accordance with an embodiment of the disclosure. In this regard, process 1400 may operate in relation to any of the various live images, reference images, and/or combined images discussed herein and/or illustrated in the various drawings of the present disclosure. In embodiments, process 1400 may be performed by logic device 168 of portable device 101 (e.g., camera 200) and/or remote system 198. In some embodiments, process 1400 may be performed during runtime operation of inspection system 100 to permit real-time inspection of one or more assets (e.g., asset 192). Note that one or more operations in FIG. 14 may be combined, omitted, and/or performed in a different order as desired. In various embodiments, any of the features of process 1400 may be combined with, substituted for, and/or otherwise used with any of the features of process 700.

Blocks 1410, 1415, 1420, and 1425 may be performed as discussed with regard to blocks 710, 715, 720, and 725, respectively.

In block 1430, camera 200 optionally receives a user selection of a transparency amount as discussed. In block 1435, logic device 168 prepares semi-transparent reference image 900 according to the transparency amount selected in block 1410. For example, in some embodiments, logic device 168 may process an opaque reference image (e.g., having a transparency amount of 0 percent) previously received in block 1425 to adjust its transparency amount. In some embodiments, the reference image may already exhibit a predetermined transparency amount (e.g., 50 percent or another amount) as stored by memory 172 and/or database 199, or as pre-processed by logic device 168 and/or remote system 198.

In block 1440, logic device 168 prepares a blended image (e.g., any of blended images 1100, 1200, 1300, or others depending on the selected transparency amount) using live image 800 and semi-transparent reference image 900. Various techniques may be used to perform blending such as alpha blending, Poisson blending, gradient mixing, and/or other techniques as appropriate. In some embodiments, the blending performed in block 1440 comprises superimposing semi-transparent reference image 900 over live image 800. In block 1445, camera 200 displays the resulting blended image on display component 178 for review by a user.

In block 1450, process 1400 includes receiving (e.g., at camera 200) a manipulation to align camera 200 relative to the asset based on a review (e.g., by a user and/or machine-based processing) of the blended image. The manipulation may adjust at least one of a position, an angle, or a field of view of the camera to align live image 800 with semi-transparent reference image 900 as shown in the blended image.

In block 1455, process 1400 includes capturing (e.g., by camera 200) an adjusted (e.g., updated) live image following the manipulation performed in block 1450 as similarly discussed in block 755 of process 700.

In block 1460, logic device 168 prepares an updated blended image using the updated live image and the semi-transparent reference image as similarly discussed in block 1440. In block 1465, camera 200 displays the resulting updated blended image on display component 178 for review by a user. Thus, it will be appreciated that by preparing and updated blended images while the user manipulates camera 200, the user may conveniently and efficiently align camera 200 to capture live images that are aligned with reference images.

Any or all of the operations of process 700 and/or process 1400 may be repeated for a plurality of assets, a plurality of images (e.g., live images, adjusted live images, updated live images, reference images, blended images, updated blended images, and/or others discussed herein) as appropriate.

Other implementations are also contemplated. For example, in some embodiments, reference image 900 and live image 800 may be selectively blended (e.g., using alpha blending or otherwise) according to a particular transparency amount to achieve a blended image without requiring the transparency preprocessing of block 1435 (e.g., block 1430 may be followed by block 1440).

In view of the present disclosure, it will be appreciated that blending semi-transparent reference images with live images may permit a user to easily discern misalignments and offsets between the images during asset inspection operations. As a result, asset data (e.g., thermal images and associated measurements) may be more consistently recorded and potential problems associated with the assets may be more quickly located and identified.

Where applicable, various embodiments provided by the present disclosure can be implemented using hardware, software, or combinations of hardware and software. Also, where applicable, the various hardware components and/or software components set forth herein can be combined into composite components comprising software, hardware, and/or both without departing from the spirit of the present disclosure. Where applicable, the various hardware components and/or software components set forth herein can be separated into sub-components comprising software, hardware, or both without departing from the spirit of the present disclosure. In addition, where applicable, it is contemplated that software components can be implemented as hardware components, and vice-versa.

Software in accordance with the present disclosure, such as program code and/or data, can be stored on one or more computer readable mediums. It is also contemplated that software identified herein can be implemented using one or more general purpose or specific purpose computers and/or computer systems, networked and/or otherwise. Where applicable, the ordering of various steps described herein can be changed, combined into composite steps, and/or separated into sub-steps to provide features described herein.

Embodiments described above illustrate but do not limit the invention. It should also be understood that numerous modifications and variations are possible in accordance with the principles of the present invention. Accordingly, the scope of the invention is defined only by the following claims.

What is claimed is:

1. A method comprising:
capturing, by a camera, a live image of an asset under inspection;
preparing a blended image using the live image and a semi-transparent reference image of the asset, wherein the blended image comprises a first representation of the asset from the live image and a second representation of the asset from the semi-transparent reference image; and
receiving, at the camera, a manipulation to align the camera relative to the asset in response to a review of an alignment of the first and second representations of the asset relative to each other in the blended image.

2. The method of claim 1, further comprising:
displaying the blended image to a user of the camera; and
wherein the review and the manipulation are performed by the user.

3. The method of claim 1, further comprising processing an opaque reference image to provide the semi-transparent reference image.

4. The method of claim 3, further comprising:
receiving a user selection of a transparency amount; and
wherein the processing is performed to provide the semi-transparent reference image exhibiting the transparency amount.

5. The method of claim 1, wherein the preparing the blended image comprises superimposing the semi-transparent reference image over the live image.

6. The method of claim 1, wherein the preparing the blended image comprises alpha blending the semi-transparent reference image with the live image.

7. The method of claim 1, further comprising:
capturing, by the camera, an updated live image of the asset following the manipulation;
preparing an updated blended image using the updated live image and the semi-transparent reference image, wherein the updated blended image comprises a third representation of the asset from the updated live image and the second representation of the asset from the semi-transparent reference image; and
receiving, at the camera, a further manipulation to align the camera relative to the asset in response to a review of an alignment of the second and third representations of the asset relative to each other in the updated blended image.

8. The method of claim 1, wherein the manipulation adjusts at least one of a position, an angle, or a field of view of the camera to align the live image with the semi-transparent reference image.

9. The method of claim 1, further comprising receiving, by the camera, an identification of the asset to be inspected, wherein the identification is based on at least one of:
a predetermined inspection route;
a detected position of the camera relative to the asset;
a communication between the camera and the asset; or
a user input.

10. The method of claim 1, wherein the camera is a portable thermal camera, the live image is a thermal live image, and the semi-transparent reference image is a semi-transparent thermal reference image.

11. A system comprising:
a camera configured to:
capture a live image of an asset under inspection;
prepare a blended image using the live image and a semi-transparent reference image of the asset, wherein the blended image comprises a first representation of the asset from the live image and a second representation of the asset from the semi-transparent reference image; and
receive a manipulation to align the camera relative to the asset in response to a review of an alignment of the first and second representations of the asset relative to each other in the blended image.

12. The system of claim 11, wherein:
the camera is configured to display the blended image to a user of the camera; and
the review and the manipulation are performed by the user.

13. The system of claim 11, wherein the camera is configured to process an opaque reference image to provide the semi-transparent reference image.

14. The system of claim 13, wherein the camera is configured to:
receive a user selection of a transparency amount; and
provide the semi-transparent reference image exhibiting the transparency amount.

15. The system of claim 11, wherein the camera is configured to superimpose the semi-transparent reference image over the live image to prepare the blended image.

16. The system of claim 11, wherein the camera is configured to alpha blend the semi-transparent reference image with the live image to prepare the blended image.

17. The system of claim 11, wherein the camera is configured to:
capture an updated live image of the asset following the manipulation;
prepare an updated blended image using the updated live image and the semi-transparent reference image, wherein the updated blended image comprises a third representation of the asset from the updated live image and the second representation of the asset from the semi-transparent reference image; and
receive a further manipulation to align the camera relative to the asset in response to a review of an alignment of the second and third representations of the asset relative to each other in the updated blended image.

18. The system of claim 11, wherein the manipulation adjusts at least one of a position, an angle, or a field of view of the camera to align the live image with the semi-transparent reference image.

19. The system of claim 11, wherein the camera is configured to receive an identification of the asset to be inspected, wherein the identification is based on at least one of:
a predetermined inspection route;
a detected position of the camera relative to the asset;
a communication between the camera and the asset; or
a user input.

20. The system of claim 11, wherein the camera is a portable thermal camera, the live image is a thermal live image, and the semi-transparent reference image is a semi-transparent thermal reference image.
